(19) United States
(12) Patent Application Publication
(10) Pub. No.: US 2013/0057478 A1
(43) Pub. Date: Mar. 7, 2013

(54) Ethiopic computer keyboard

(71) Applicant: Gudato Rahmato, Oslo (NO)

(72) Inventor: Gudato Rahmato, Oslo (NO)

(21) Appl. No.: 13/199,608

(22) Filed: Sep. 6, 2011

(51) Int. Cl. G06F 3/02

(52) U.S. Cl. 345/171

(57) ABSTRACT

A Unicode based non phonetic Ethiopic computer keyboard with a unique key arrangement which is easy-to-learn and requires the user to press a maximum of only two keys to type any character without knowledge of English, including keys for all Ethiopic major characters, Ethiopic numerals and extended characters.

### BACKGROUND OF THE INVENTION

1. Field of the Invention

The present invention relates to a computer keyboard designed for use with the Ethiopian language.

2. Description of the Prior Art

Keyboards are known to be one of the major input devices in computers whereby a user enters data or commands to the computer. Keyboards play a significant role in building up communications between the computer and the human user and are designed in different ways to accommodate characters of a large variety of languages. One major aspect regarding designing computer keyboards is their size and the limited number of keys as compared to the number of characters of the character set which is of concern. A typical example would be the Ethiopian character set which consists of more than 327 characters.

A standard keyboard that is included in the language and regional options of Microsoft's windows operating system is not yet available in Ethiopia.

What is thus desired is to provide a keyboard for the Ethiopian language that has 356 characters accommodated on a standard computer keyboard having 102 keys, including 33 alpha keys.

### SUMMARY OF THE INVENTION

The present invention provides an easy-to-use non-phonetic Ethiopic computer keyboard where all characters in the Ethiopic character set are systematically accommodated. Since it is not possible to have keys for all the characters on the keyboard due to the limited size of a typical computer keyboard, the keyboard of the present invention is designed to take advantage of the structure of the Ethiopic character set which comprises a table where characters are grouped in columns and are labeled as Geez [symbol] , Kaeb [symbol] , Sals [symbol] , Rabe [symbol] , Hams [symbol] , Sads [symbol] , Sabe [symbol] and shift keys which are labeled [symbol] . Examples are [symbol] , [symbol] , [symbol] , [symbol] , [symbol] , [symbol] , [symbol] , [symbol] . From Geez to Shift respectively. The nature of the character set allows each column to make a group and assign a limited number of keys for each group at a time. A feature of the keyboard design takes one of the groups as primary and the rest as subsidiary. This implies that characters in the primary group are assigned single keys whereas the subsidiary group characters are typed with a maximum combination of two key strokes. Since the keyboard has a maximum of two key combinations it avoids the problem of having to press more than two keys at a time.

The present invention provides a Geez layout. In the Geez layout, Geez characters are taken as the primary group. Thus, all Geez characters are typed by pressing a single key and all the others are typed by pressing their corresponding Geez character key with a designed Geez key.

Characters in these keyboard layouts are carefully arranged to make a pattern that users can easily learn and remember. Its unique advantages extend to not requiring the user to know the whole Ethiopic alphabet. Phonetic keyboards work by assigning Geez characters to their phonetically identical English letters and a combination of these and vowel letters to type the remaining characters. Therefore, the user needs to know which vowel makes a sound of which character and hence knowledge of the English language is not required. Other features of the keyboard include punctuation symbols, Ethiopic numerals and extended characters such as [symbol] . This system is based on Unicode and it works on all applications. The keyboard enables a user to chat, compose and send an email in Amharic. The name of files and folders can be changed to Amharic. Moreover, any given Ethiopic character can be typed with not more than two keys.

Users can type faster when using a non-phonetic keyboard because the keys are arranged according to their frequency of use. Thus, characters which are used often in Ethiopian languages are placed in the most convenient area of the keyboard.

### DESCRIPTION OF THE DRAWINGS

For a better understanding of the present invention as well as other objects and further features thereof, reference is made to the following description which is to be read in conjunction with the accompanying drawing therein:

FIG. 1 shows first form characters of Ethiopic characters;

FIG. 2 shows the shift state of the first form characters;

FIG. 3 shows first form Ethiopic characters when the caps lock [symbol] is on;

FIG. 4 shows the shift state of the first form characters when the caps lock [symbol] state is on;

FIG. 5 shows the switching keys needed to type the second to seventh form characters;

FIG. 6 shows a 102 Ethiopic keyboard layout;

FIG. 7 is a flowchart of the result for different combinations of keys; and

FIG. 8 is a block diagram showing integral parts of the apparatus used in the invention.

### DESCRIPTION OF THE INVENTION

A typical keyboard has four primary categories of keys. These are typing, control, numeric, and function keys. The typing keys are the letter keys and are used most often. The control keys allow control of the cursor and screen. Common control keys are the arrow keys, Insert ( [symbol] ), Delete ( [symbol] ), Home ( [symbol] ), End ( [symbol] ), Page up ( [symbol] ), Page Down ( [symbol] ), Control (Ctrl) ( [symbol] ), Escape (Esc) ( [symbol] ), Left Alternate (L/A) ( [symbol] ) and Right Alternate ( [symbol] ) The numeric keys are number keys typically found at the far right of a keyboard and are a series of 17 keys arranged like a common calculator. Finally, the function keys are assigned specific commands by the current computer application. They are found in a row at the top of the keyboard (F1 through F12). The advantage of the keyboard of the present invention is that no one must know English words to write Amharic. Anyone who wants to write Amharic can type using the shift (switching) keys which are commonly known by Ethiopians. Geez letters can be written without the need of the switching keys. Kaeb (110 [symbol] ), sals (120 [symbol] ), rabe (130 [symbol] ), hams (140 [symbol] ), sads (150 [symbol] ), sabe (160 [symbol] ) and shift (170 [symbol] ) are used as switching keys to get Ethiopic characters other than Geez whereas in the phonetic case English vowels are used as switching keys.

Users can type faster when using the non phonetic keyboard because the keys are arranged with their degree of frequent use. Characters which are used often in Ethiopian languages are placed in the most comfortable area of the keyboard. Sads (150 [symbol] ) characters which are the most frequently used characters can also be written with a great ease by choosing from two switching keys.

The switching keys are arranged in a patterned way which means the fingers go to the same parts of the keyboard most of the time.

All Ethiopian characters beginning from Kaeb (110 [symbol] ) to shift (170 [symbol] ) except sabe (160 [symbol] ) can be written using two switch keys. For example if you want to write [symbol] you can use the “ [symbol] ” (on the left) or “ [symbol] ” (on the right) plus [symbol] .

Some Ethiopian words can have more than two meanings depending on the intensity of their pronunciation. For example the Amharic word “ [symbol] ” has two meanings. One meaning of this word is “the existence of something” and the other is “a reference to what someone said”. These kinds of words can be written by first writing the word then pressing the shift (170 [symbol] ) key+i key or also known as the accent key in the Latin keyboard. So the result will be [symbol] .

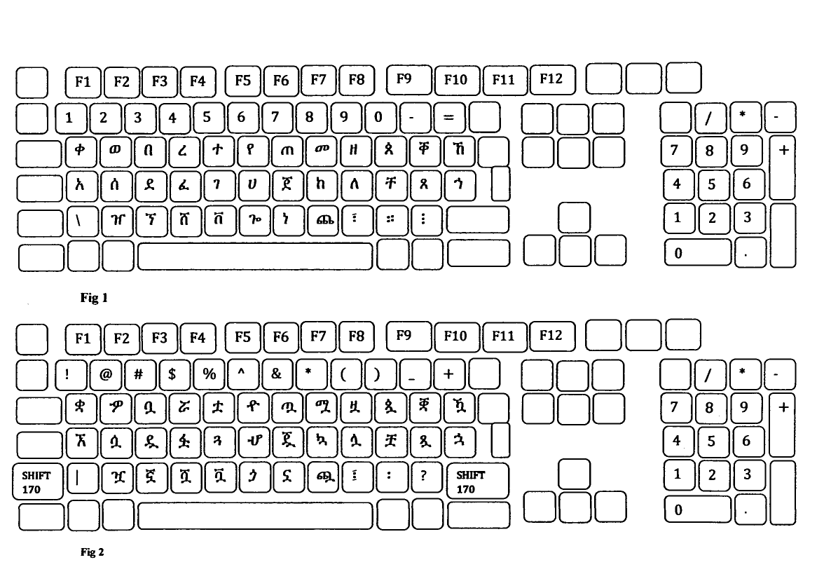

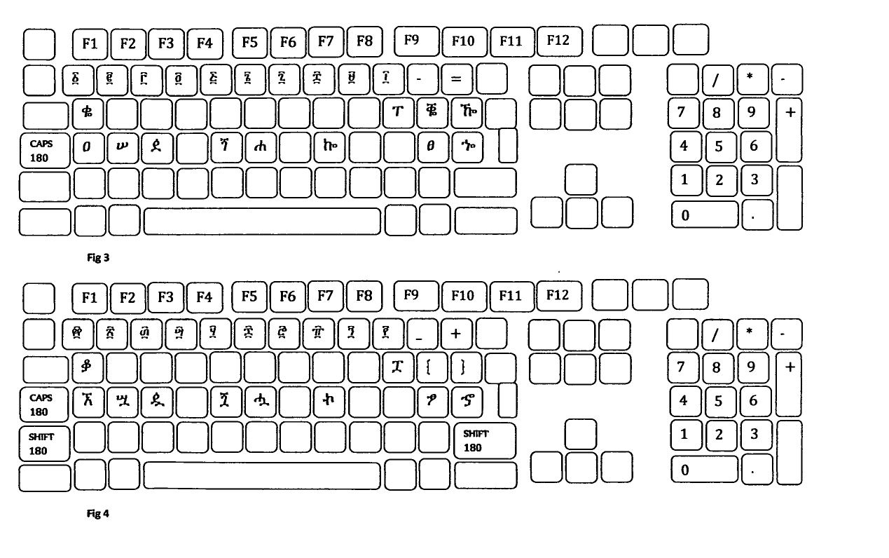

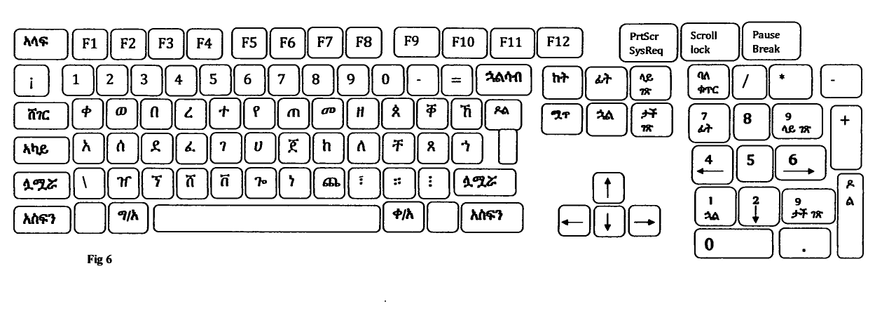

The Ethiopian alphabet has 327 characters in eight forms. It begins with a primary form called Geez (100) which has 43 letters. This is in keyboard layout (10) as shown in FIG. 1. The second form called Kaeb 110 (native language also means 2^{nd}) has 37 letters, the third form Sals 120 (3^{rd}) has 43 letters, the fourth form Rabe 130 (4^{th}) has 43 letters, the fifth form Hams 140 5^{th} has 43 letters, the sixth form Sads 150 (6^{th}) has 43 letters, the seventh form called Sabe 160 (7^{th}) has 37 letters. From the Kaeb form (110) to the Sabe (160) to the seventh form (except the eighth form which is written using two Shift 170 keys and also has 38 letters (FIGS. 2 and 4). All Ethiopic characters can also be typed with great ease choosing from their own pair of switching keys (dead key): Kabe (110), Sals (120), Rabe (130), Hams (140), Sads (150), and Sabe (160), including both Shift keys (170). The Latin alphabet has 52 characters in two forms. The first 26 primary characters have a form called Small letter and the second 26 characters have a form called Capital letter. Thus, the primary small letters based as layout and the second form Capital letter can be written using two Shift keys even if the two kinds of forms have slight differences and have the same sound with the other. In the same analogy, the keyboard of the present invention works in a similar manner as a Latin base keyboard but with eight forms including the first form (Geez) which is the base and part of the layout. Example to write one full sickle of eight form in a single letter+“ [symbol] ” (Geez) 1^{st} form, Kaeb+“ [symbol] ”=>“ [symbol] ” 2^{nd} form, Sals+“ [symbol] ”=>“ [symbol] ” 3^{rd} form, Rabe+“ [symbol] ”=>“ [symbol] ” 4^{th} form, Hams+“ [symbol] ”=>“ [symbol] ” 5^{th} form, Sads+“ [symbol] ”=>“ [symbol] ” 6^{th} form, Sabe+“ [symbol] ”=>“ [symbol] ” 7^{th} form and Shift+“ [symbol] ”=>“ [symbol] ” 8^{th} form.

In the present invention all keys printed on the keyboard are Amharic. They are set forth in the table below with their English meanings:

| | |
|---|---|
| Backspace | [symbol] |
| Esc | [symbol] |
| Tab | [symbol] |
| Enter | [symbol] |
| Caps Lock | [symbol] |
| Shift | [symbol] |
| Ctrl | [symbol] |
| Alt(left) | [symbol] |
| Alt(right) | [symbol] |
| Insert | [symbol] |
| Home | [symbol] |
| End | [symbol] |
| Page Up | [symbol] |
| Page Down | [symbol] |
| Delete | [symbol] |
| Num Lock | [symbol] |

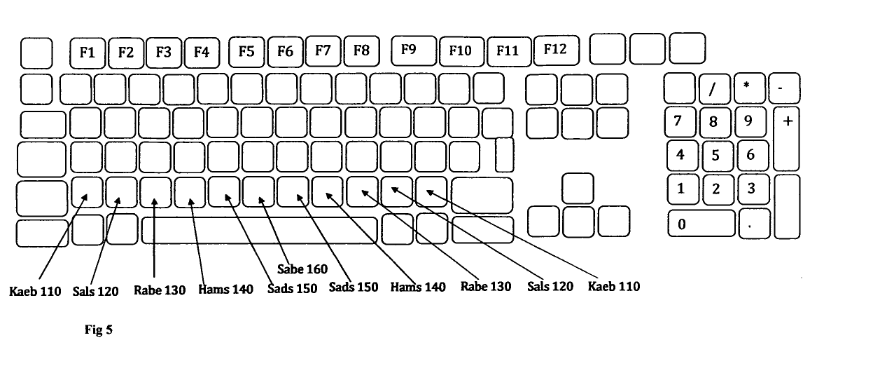

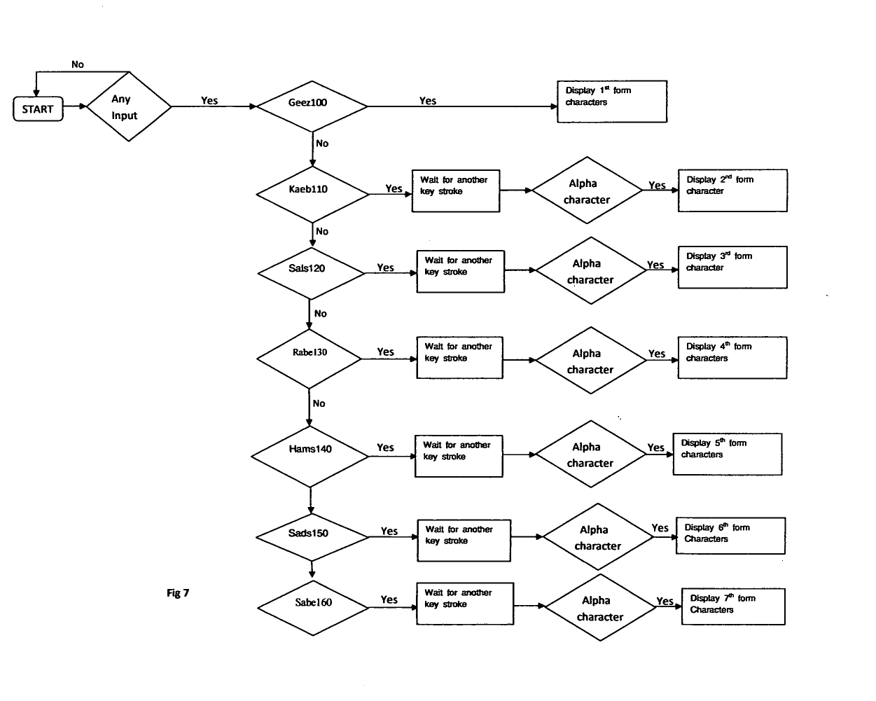

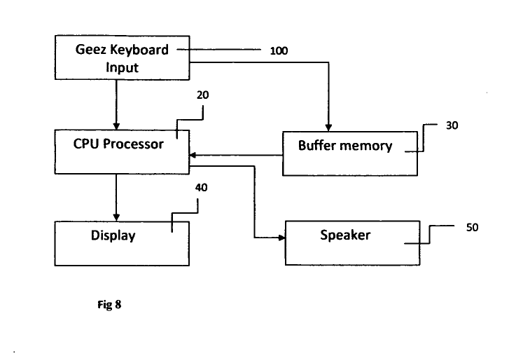

FIG. 1 illustrates the keyboard layout for a first form Geez (100) characters; FIG. 2 illustrates the keyboard layout using shift (170) characters; FIG. 3 illustrates the keyboard layout for Geez (100) characters which are displayed when the CAPS LOCK (180) key is activated; FIG. 4 illustrates the shift state of characters when the CAPS LOCK (180) and SHIFT STATE (170) keys are activated; FIG. 5 is a keyboard layout when keys 110-160 are dead keys but function as shift keys and FIG. 6 illustrates a keyboard layout which incorporates the teachings of the present invention.

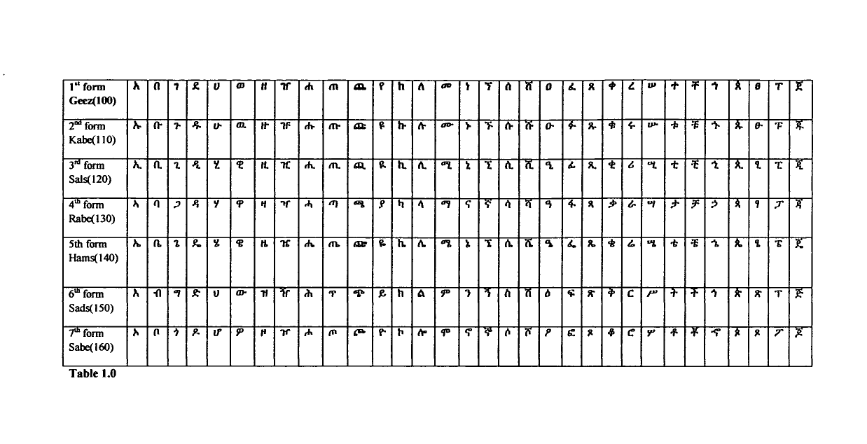

FIG. 7 is a flowchart illustrating how the keyboard of FIG. 6 works when different combinations of keys are used. Note that the functions shown in the flowchart can be implemented by a microprocessor. The “alpha” characters shown in the flowchart are non-numerical and non-punctuation Ethiopic characters.

The user starts the keyboard by powering up the processor (block 500); if the processor determines that there is no input (block 502), the system returns to start. If an input is detected, the processor determines whether it corresponds to the Geez 100 (block 504); if yes, the processor monitor displays the first form characters (block 506). If Geez 100 is not detected, the processor determines if the input is Kabe 110 (block 508); if yes, the processor waits for a second stroke (block 510) and if it is an Alpha character (block 512), the 2^{nd} form characters are caused to be displayed (block 514). If Kabe 110 is not detected, the processor determines whether the input is Sals 120 (block 516); if yes, the processor waits for a second stroke (block 518) and whether it is an Alpha character (block 520) and if such a character is detected, the monitor displays the 3^{rd} form characters (block 522). If Sals 120 is not detected, the processor determines whether Rabe 130 has been detected (block 524); if yes, the processor waits for a second stroke (526), determines if an Alpha character is present (block 528) and, if present, the monitor displays the 4^{th} form characters (block 530). If Rabe 130, is not detected, the processor determines if Hama 140 is present (block 532); if yes, the processor waits for a second stroke (block 534) and if an Alpha character is detected (block 536) causes the 5^{th} form to be displayed (block 538). If Hama 140 is not detected, the processor determines if Sads 150 is present (block 540); if yes, the processor determines if a second stroke has occurred (block 540), if yes, the processor waits for a second stroke (block 542), determines if an Alpha stroke is present (block 544) and if yes, displaying the 6^{th} form characters (block 546). If Sads 150 is not detected, the processor determines Sabe 160 is present (block 548); if yes the processor determines whether a second stroke has occurred (block 550), determines if a Alpha character is present (block 552) and if so, displays the 7^{th} form characters.

FIG. 8 is a simplified block diagram of the components that utilize the Geez keyboard 100 of the present invention. In particular, the keyboard input is monitored by CPU processor 20 which controls display 40 and speaker 50 (optional). The output of keyboard 100 is also coupled to buffer memory 30, memory 30 interacting with processor 100.

An example of how the keyboard of the present invention is utilized is set forth hereinafter.

An example of a sentence in the Ethiopian language is as follows:

[symbol]

[symbol]

[symbol]

[symbol]

[symbol]

[symbol]

[symbol]

[symbol]

The sentence (2) that follows illustrates how sentence (1) hereinabove is written phonetically in English:
Ethiopia yenaile wenz yetefasesu ageroch yegara habet newe bela tamenalech

Sentence (3) herein below is an English translation of sentence (1):
“Ethiopia believes that the river Nile is the property of all the countries it touches”.

The samples that follow show how each letter in the sentence is written using the Ethiopian keyboard of the present invention. The characters written in italic are the switching keys:
Take the first word [symbol] in sentence 1

The first letter is [symbol] and is a 3^{rd} form character. In order to type it, the 1^{st} form of the letter is required. The first form of the letter [symbol] is [symbol] . FIG. 5 shows 11 switching keys to retrieve characters from the 2^{nd} to the 7^{th} form. The switching keys are located in the fifth row of the keyboard. The user has the choice of pressing from two switching keys for 2^{nd} to 6^{th} form characters but have one choice for 7^{th} form characters.

1^{st} form characters are called Geez and are typed as shown in the keyboard without the need of key combination.

2^{nd} form characters are called Kabe and the switching keys used are \ or

[symbol]

3^{rd} form characters are called Sals and the switching keys used are [symbol] or

[symbol]

4^{th} form characters are called Rabe and the switching keys used are [symbol] or

[symbol]

5^{th} form characters are called Hams and the switching keys used are [symbol] or at

[symbol]

6^{th} form characters are called Sads and the switching keys used are [symbol] or

[symbol]

7^{th} form characters are called Sabe and the switching key used is

[symbol]

So to write [symbol] we press [symbol] or [symbol] first then we press the 1st form of [symbol] which is

[symbol]

Each word in sentence 1 is written on the Ethiopian keyboard as follows:

Referring again to FIG. 1, all first form characters are displayed on the keyboard; combination of keys need not be typed. The Ethopic characters shown in FIG. 3 similarly do not need a key combination to be typed.

Referring to FIG. 6, the 1^{st} form characters are displayed initially on the keyboard. In order to type the other (2^{nd} to 7^{th}) form characters, the switching keys displayed on the fifth row of the keyboard is used.

Only the 1st form Or Geez (100) characters are displayed on the keyboard and can be written with one key press. The other forms (2^{nd} to 7^{th}) are typed by using switching keys (dead keys) as displayed on FIG. 5. The Latin keyboard in comparison and assuming all small letters are 1^{st} form characters, capital letters are written (assume they are 2^{nd} form) the shift key with the small letter key is used. The Ethiopian keyboard has more than 300 characters so they need to be divided into 8 forms and these 8 forms are typed by using 8 switch keys which include the shift key.

Table 1.0 illustrates the 1^{st form to} 7^{th} form Ethiopic characters.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. An Ethiopic computer keyboard with specific key arrangements such that a user needs to press a maximum of two keys to type any Ethiopic character.

2. A keyboard according to claim 1, wherein the key arrangements are in the Geez language.

3. The Ethiopic computer keyboard of claim 1 wherein the specific key arrangements are in the Sads language.
